(19) United States
(12) Patent Application Publication
(10) Pub. No.: US 2009/0308669 A1
(43) Pub. Date: Dec. 17, 2009

(54) QUAD TRACK VEHICLE

(75) Inventors: Matthew Stephen Vos, Pella, IA (US); Ronald Scott Hansen, Kindred, ND (US)

Correspondence Address: MERCHANT & GOULD PC, P.O. BOX 2903, MINNEAPOLIS, MN, 55402-0903, US

(73) Assignee: Vermeer Manufacturing Company, Pella, IA (US)

(21) Appl. No.: 12/546,382

(22) Filed: Aug. 24, 2009

Related U.S. Application Data
(63) Continuation of application No. 29/332,009, filed on Feb. 6, 2009.
Application No. 29/332,009 is a division of application No. 29/292,551, filed on Oct. 15, 2007, now Pat. No. D587727.

(51) Int. Cl. B62D 55/065; E02F 5/02; E02F 3/28

(52) U.S. Cl. 180/9.23; 37/347; 37/447; 37/365

(57) ABSTRACT

The quad track vehicle includes a chassis including a front end, a rear end and a left side and a right side. The chassis is supported on a plurality of tracks. Each of the tracks defines a generally triangular shape. The plurality of tracks includes a front left track at the left side of the chassis, a front right track at the right side of the chassis, a rear left track at the left side of the chassis rearward of the front left track and a rear right track at the right side of the chassis rearward of the front right track. The rear tracks have rearward portions that project a first distance rearwardly beyond the rear end of the chassis. The front tracks have forward portions that project a second distance forwardly beyond the front end of the chassis. The second distance is less than the first distance.

### CROSS REFERENCE TO RELATED APPLICATIONS

This is a continuation of prior U.S. Design Patent Application No. 29/332,009, entitled Quad Track Trencher Profile, filed on Feb. 6, 2009, which is a division of prior U.S. Design Patent Application No. 29/292,551, entitled Quad Track Trencher, filed Oct. 15, 2007, now U.S. Pat. No. D587,727, the disclosures of which are hereby incorporated by reference in their entirety.

### BACKGROUND

The present disclosure relates to track vehicles, and more particularly, to quad track vehicles.

### SUMMARY

An aspect of the present disclosure relates to a quad track vehicle. The quad track vehicle includes a tractor chassis including a front end positioned opposite from a rear end and a left side positioned opposite from a right side. The tractor chassis is supported on a plurality of tracks. Each of the tracks defines a generally triangular shape. The plurality of tracks includes a front left track positioned at the left side of the tractor chassis, a front right track positioned at the right side of the tractor chassis, a rear left track positioned at the left side of the tractor chassis at a location rearward of the front left track and a rear right track positioned at the right side of the tractor chassis at a location rearward of the front right track. The rear left and right tracks have rearward portions that project a first distance rearwardly beyond the rear end of the tractor chassis. The front left and right tracks have forward portions that project a second distance forwardly beyond the front end of the tractor chassis. The second distance is less than the first distance.

### DRAWINGS

FIG. 1 is a perspective view of a quad track vehicle having exemplary features of aspects in accordance with the principles of the present disclosure.

FIG. 2 is a front elevational view of the quad track vehicle of FIG. 1.

FIG. 3 is a rear elevational view of the quad track vehicle of FIG. 1.

FIG. 4 is a right side elevational view of the quad track vehicle of FIG. 1.

FIG. 5 is a left side elevational view of the quad track vehicle of FIG. 1.

FIG. 6 is a top plan view of the quad track vehicle of FIG. 1.

FIG. 7 is a bottom plan view of the quad track vehicle of FIG. 1.

FIG. 8 is a second perspective view of the quad track vehicle of FIG. 1.

FIG. 9 is a left side elevational view of the quad track vehicle of FIG. 1 showing a first set of implements mounted on the front and rear of the quad track vehicle.

FIG. 10 is a left side elevational view of the quad track vehicle of FIG. 1 showing a second set of implements mounted on the front and rear of the quad track vehicle.

FIG. 11 is a left side elevational view of the quad track vehicle of FIG. 1 showing a third set of implements mounted on the front and rear of the quad track vehicle.

FIG. 12 is a right side elevational view of the quad track trencher of FIG. 1 showing a fourth set of implements mounted on the front and rear of the quad track vehicle.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

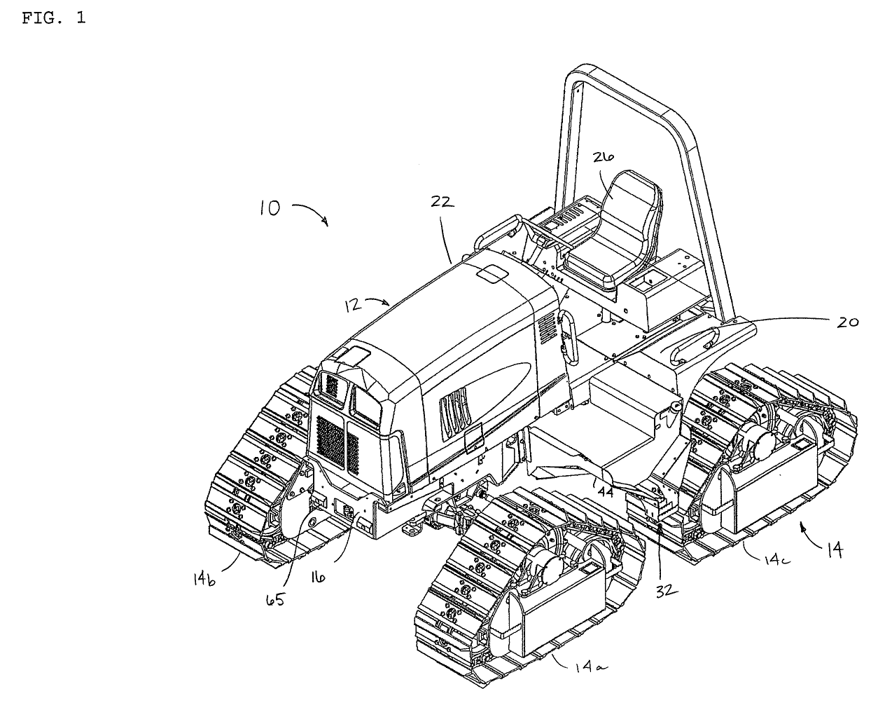

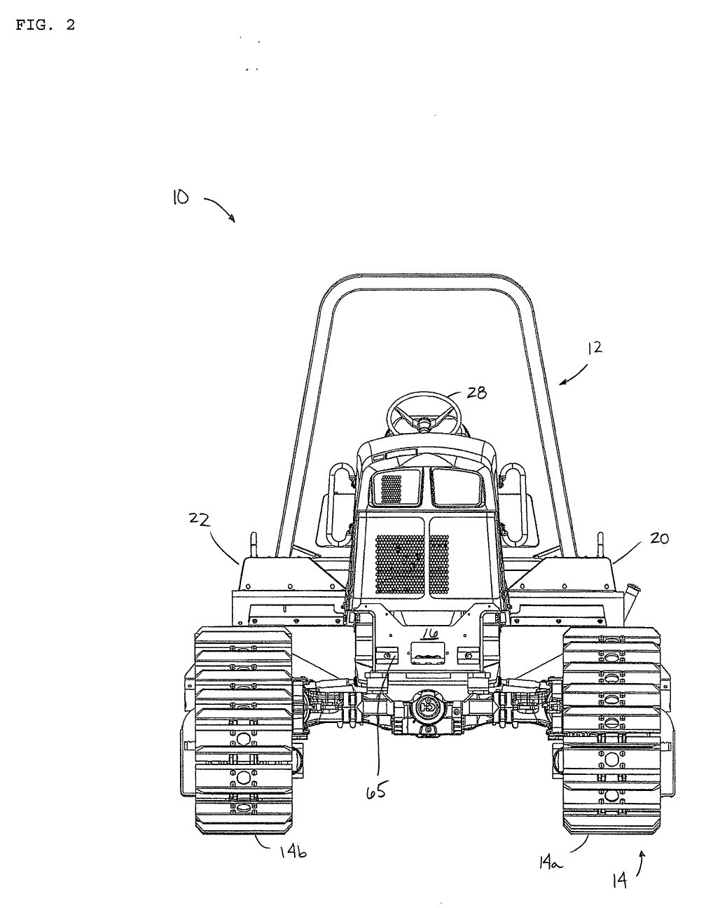

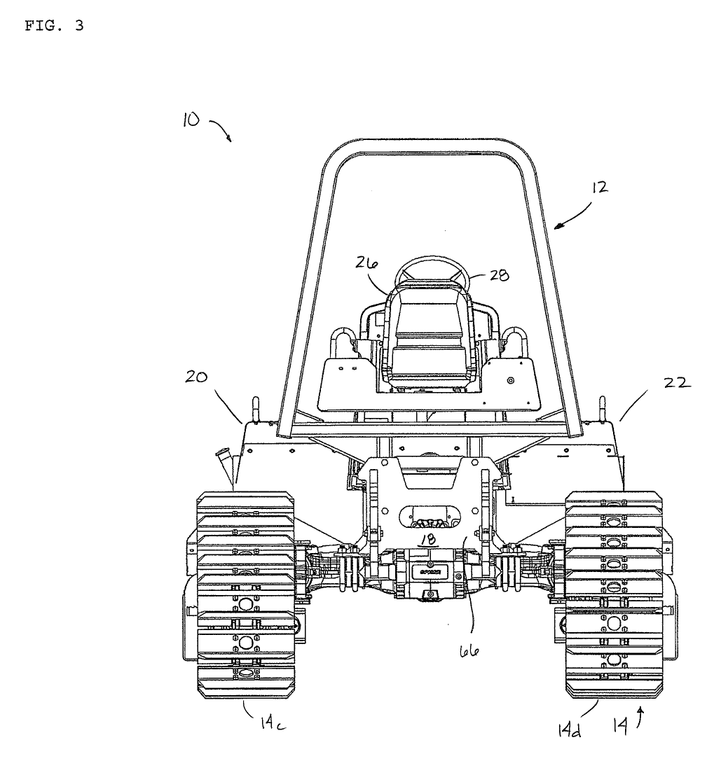

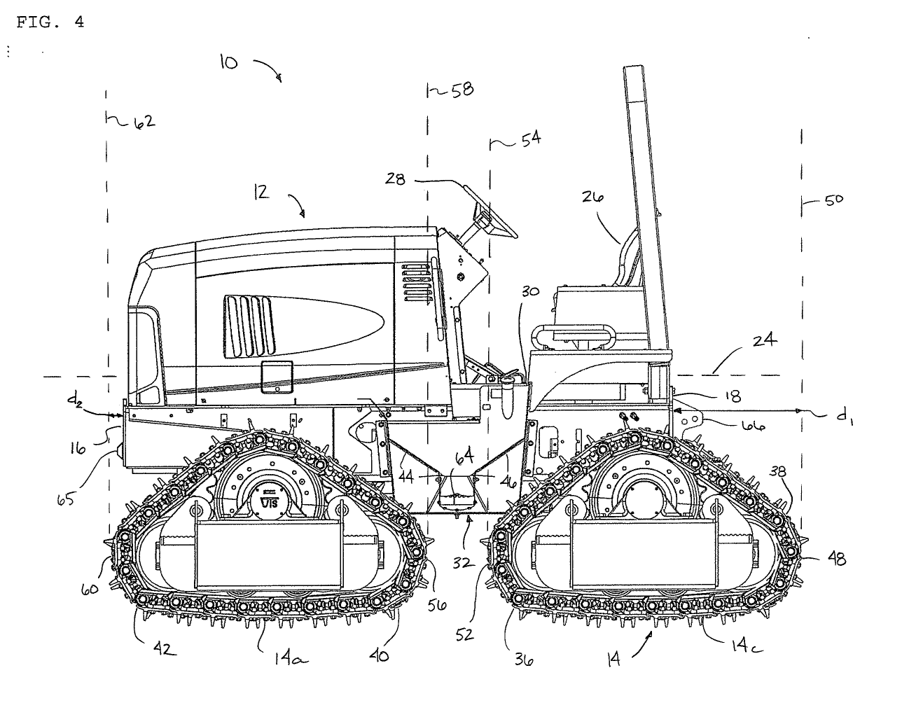

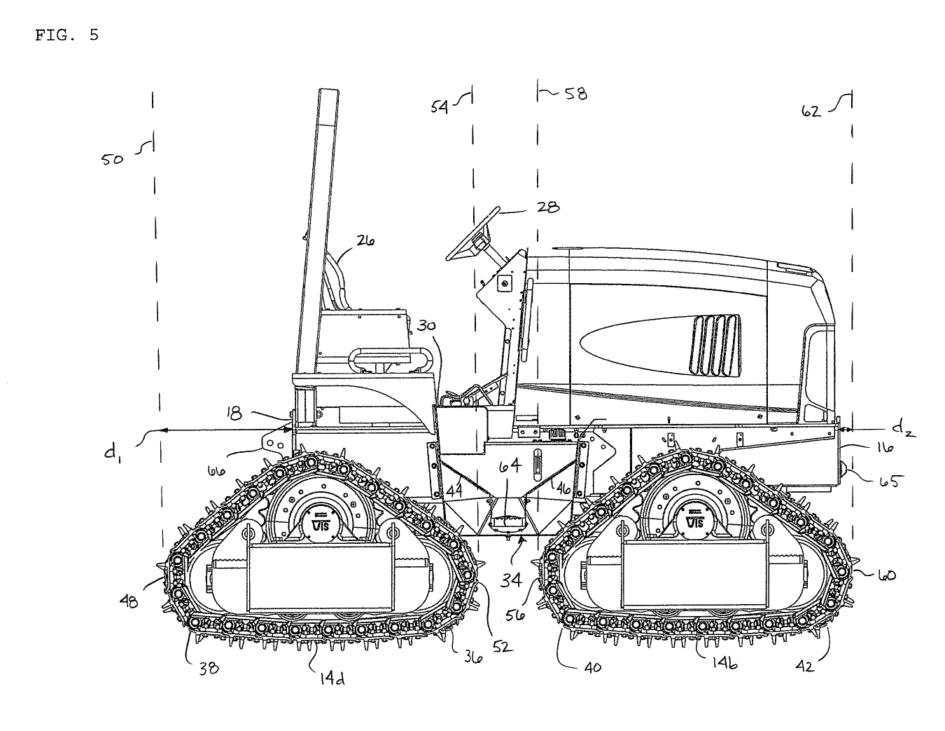

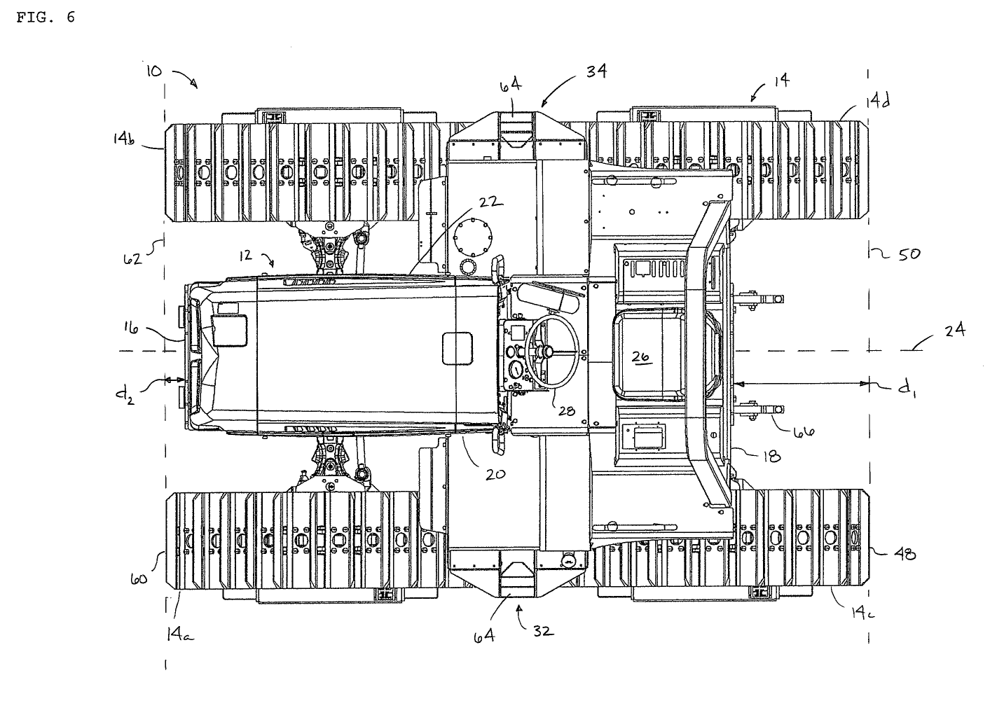

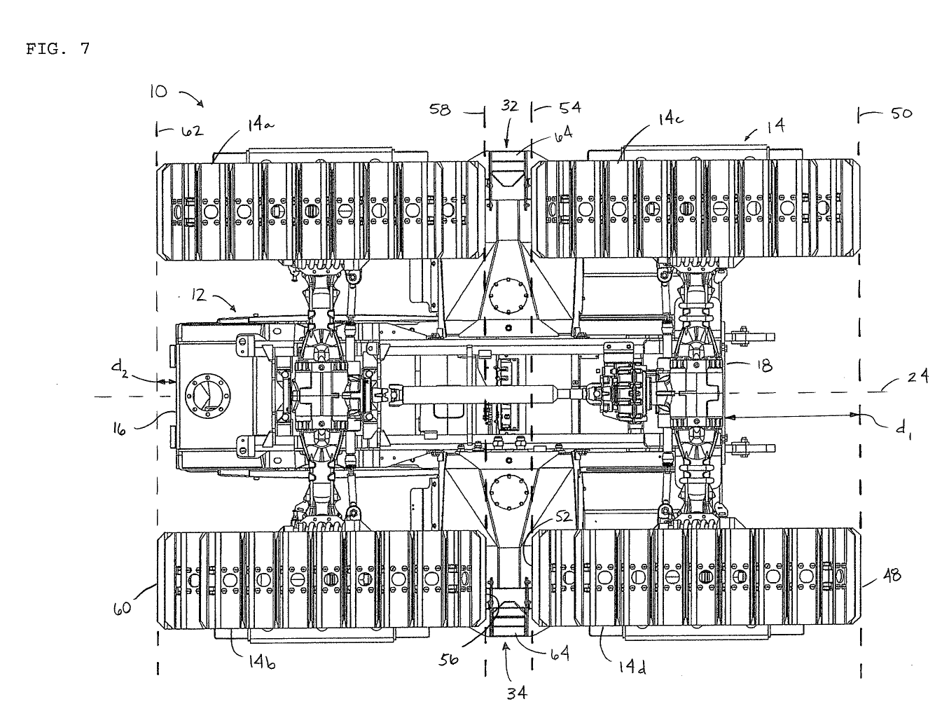

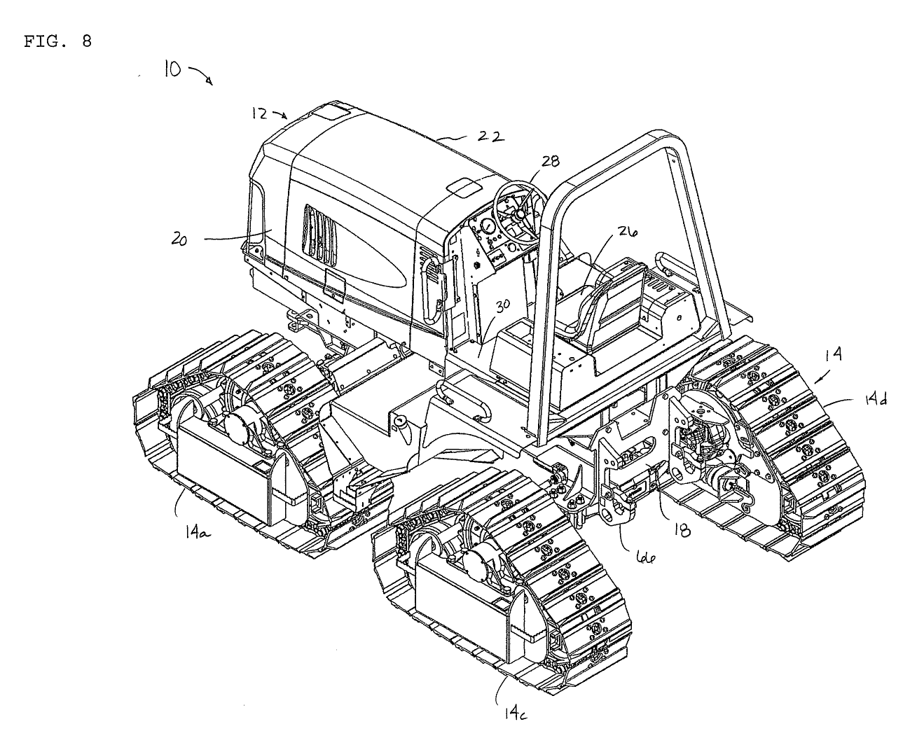

Referring now to FIGS. 1-8, a quad track vehicle, generally designated 10, is shown. The quad track vehicle 10 includes a tractor chassis 12 and a plurality of tracks 14. As shown at FIGS. 1-12, the depicted tractor chassis 12 is non-articulated.

The tractor chassis 12 includes a front end 16, an oppositely positioned rear end 18, a left side 20 and an oppositely positioned right side 22. The tractor chassis 12 defines a central longitudinal axis 24.

The tractor chassis 12 supports a driver's seat 26. A steering wheel 28 is positioned in front of the driver's seat 26. A footwell 30 is positioned in front of the driver's seat 26 and at least partially beneath the steering wheel 28.

The tractor chassis 12 includes a left step arrangement 32 positioned at the left side 20 of the tractor chassis 12 and a right step arrangement 34 positioned at the right side 22.

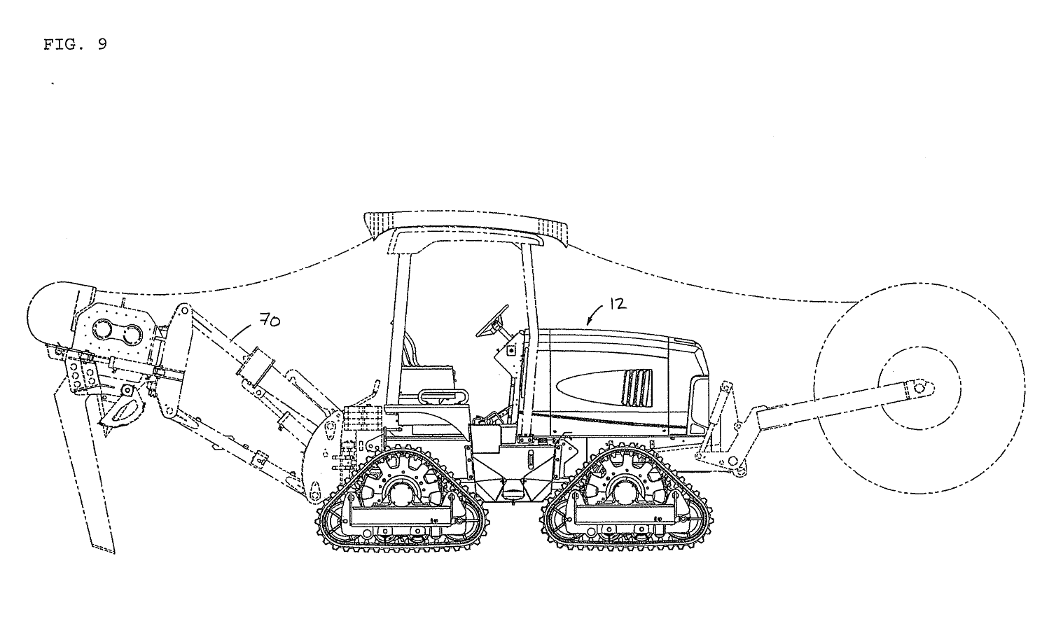

The tractor chassis 12 is supported by the plurality of tracks 14. Each of the tracks 14 defines a generally triangular shape. In one aspect of the present disclosure, each of the plurality of tracks 14 is segmented (shown in FIGS. 1-8 and 10). In another aspect of the present disclosure, each of the plurality of tracks 14 is continuous (shown in FIGS. 9 and 11-12).

The plurality of tracks 14 include a front left track 14a positioned at the left side 20 of the tractor chassis 12, a front right track 14b positioned at the right side 22 of the tractor chassis 12, a rear left track 14c positioned at the left side 20 of the tractor chassis 12 at a location rearward of the front left track 14a and a rear right track 14d positioned at the right side 22 of the tractor chassis 12 at a location rearward of the front right track 14b.

Each of the rear left and right tracks 14c, 14d includes a forward portion 36 and an oppositely disposed rearward portion 38. The forward portions 36 of the rear left and right tracks 14c, 14d extend beneath the left and right step arrangements 32, 34, respectively. The rearward portions 38 of the rear left and right tracks 14c, 14d project a first distance d₁, rearwardly beyond the rear end 18 of the tractor chassis 12.

Each of the front left and right tracks 14a, 14b includes a rearward portion 40 and an oppositely disposed forward portion 42. The rearward portions 40 of the front left and right tracks 14a, 14b extend beneath the left and right step arrangements 32, 34, respectively. The forward portion 42 of the front left and right tracks 14a, 14b project a second distance d₂ forwardly beyond the front end 16 of the tractor chassis 12. The second distance d₂ is less than the first distance d₁.

Each of the left and right step arrangements 32, 34 includes an angled front fender portion 44. The angled front fender portion 44 of each of the left and right step arrangements 32, 34 is generally parallel to the rearward portions 36 of the front left and right tracks 14a, 14b, respectively.

Each of the left and right step arrangements 32, 34 further includes an angled rear fender portion 46. The angled rear fender portion 46 of each of the left and right step arrangements 32, 34 is generally parallel to the forward portions 36 of the rear left and right tracks 14c, 14d, respectively.

Rearmost portions 48 of the rear left and right tracks 14c, 14d define a first vertical reference plane 50. The first vertical reference plane 50 is perpendicular to the central longitudinal axis 24 of the tractor chassis 12.

Frontmost portions 52 of the rear left and right tracks 14c, 14d define a second vertical reference plane 54. The second vertical reference plane 54 is perpendicular to the central longitudinal axis 24 of the tractor chassis 12.

Rearmost portions 56 of the front left and right tracks 14a, 14b define a third vertical reference plane 58. The third vertical reference plane 58 is perpendicular to the central longitudinal axis 24 of the tractor chassis 12.

Frontmost portions 60 of the front left and right tracks 14a, 14b define a fourth vertical reference plane 62. The fourth vertical reference plane 62 is perpendicular to the central longitudinal axis 24 of the tractor chassis 12.

In one aspect of the present disclosure, the driver's seat 26 is disposed entirely between the first and second vertical reference planes 50, 54. In another aspect of the present disclosure, the second vertical reference plane 54 passes through the footwell 30 and intersects the steering wheel 28.

In one aspect of the present disclosure, the footwell 30 is disposed entirely between the first and third reference planes 50, 58. In another aspect of the present disclosure, bottommost steps 64 of the left and right step arrangements 32, 34 are centered between the second and third vertical reference planes 54, 58.

Referring now to FIGS. 9-12, the tractor chassis 12 is adapted to receive various implements. The implements can be mounted to the front and rear ends 16, 18 of the tractor chassis 12. In one aspect of the present disclosure, the front end 16 includes a front implement mount 65 while the rear end 18 includes a rear implement mount 66. The front implement mount 65 is disposed between the third and fourth reference planes 58, 62. In another aspect of the present disclosure, the rear implement mount 66 is disposed between the first and second reference planes 50, 54.

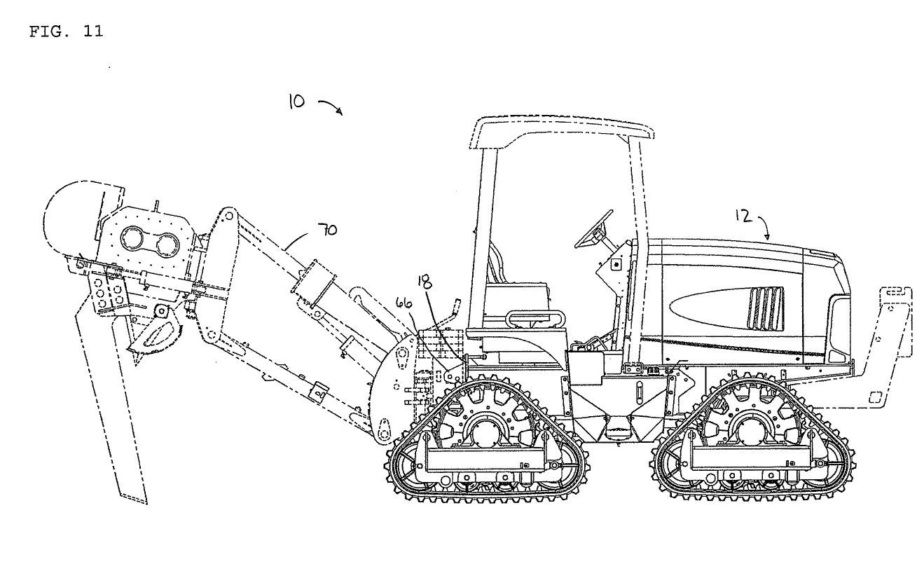

In one aspect of the present disclosure, a vibratory plow 70 (shown in FIGS. 9 and 11) is attached to the tractor chassis 12. The vibratory plow 70 is mounted to the rear end 18 of the tractor chassis 12 at the rear implement mount 66.

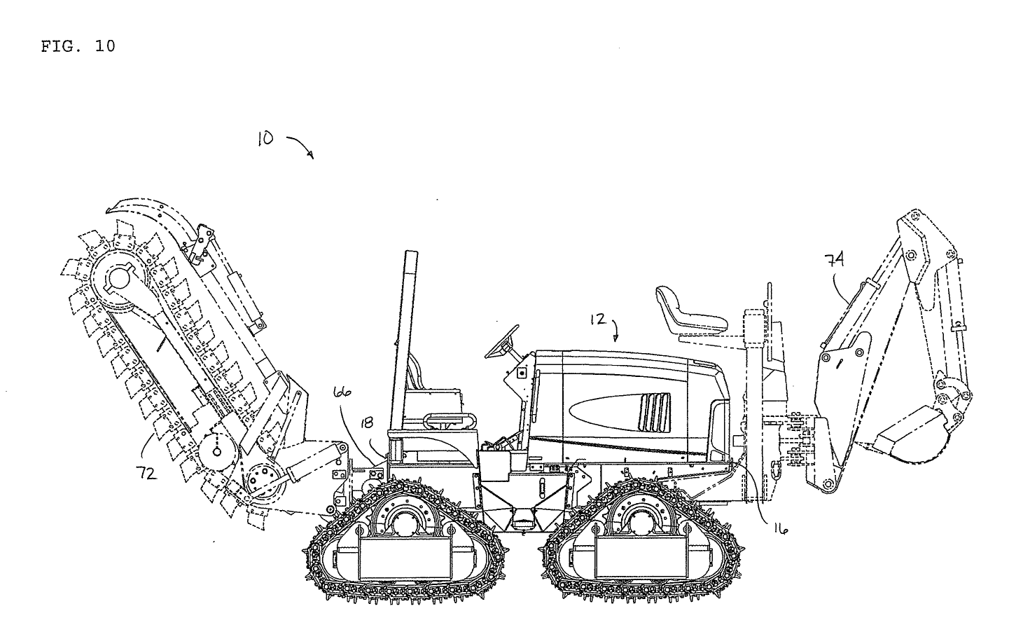

In another aspect of the present disclosure, a trencher boom 72 is attached to the tractor chassis 12. The trencher boom 72 (shown in FIG. 10) is mounted to the rear end 18 of the tractor chassis 12 at the rear implement mount 66.

In another aspect of the present disclosure, a back-hoe 74 is attached to the tractor chassis 12. The back-hoe 74 is mounted to the front end 16 of the tractor chassis 12 at the front implement mount 65.

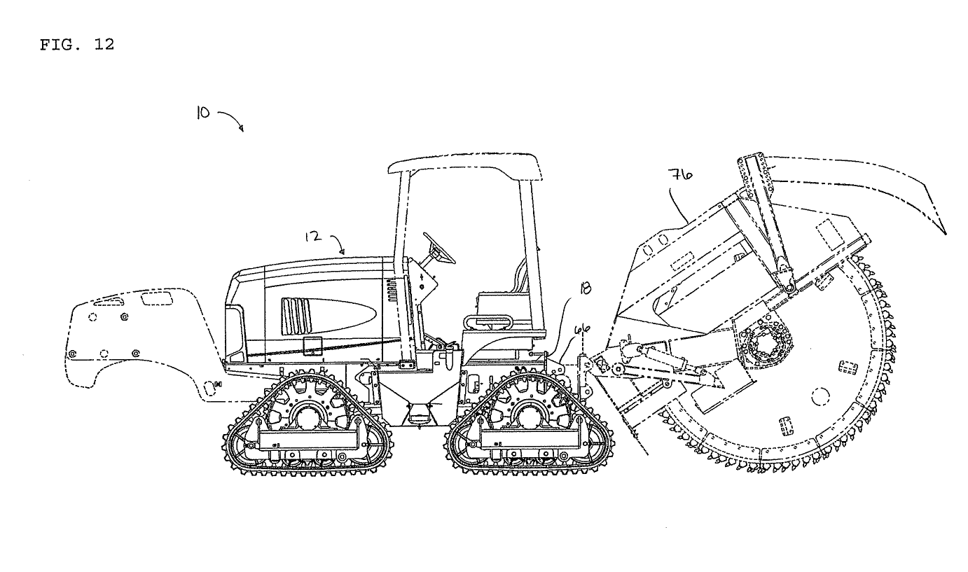

In another aspect of the present disclosure, a rock wheel 76 (shown in FIG. 12) is attached to the tractor chassis 12. The rock wheel 76 is mounted to the rear end 18 of the tractor chassis 12 at the rear implement mount 66.

What is claimed is:

1. A quad track vehicle comprising:
a tractor chassis including a front end positioned opposite from a rear end and a left side positioned opposite from a right side;
a plurality of tracks on which the tractor chassis is supported, each of the tracks defining a generally triangular shape, the plurality of tracks including a front left track positioned at the left side of the tractor chassis, a front right track positioned at the right side of the tractor chassis, a rear left track positioned at the left side of the tractor chassis at a location rearward of the front left track and a rear right track positioned at the right side of the tractor chassis at a location rearward of the front right track;
a driver's seat supported on the tractor chassis;
a steering wheel positioned in front of the driver seat;
a footwell positioned in front of the driver's seat at least partially beneath the steering wheel;
a left step arrangement positioned at the left side of the tractor chassis and a right step arrangement positioned at the right side of the tractor chassis;
the rear left and right tracks having forward portions that extend respectively beneath the left and right step arrangements;
the front left and right tracks having rearward portions that extend respectively beneath the left and right step arrangements;
the rear left and right tracks having rearward portions that project a first distance rearwardly beyond the rear end of the tractor chassis;
the front left and right tracks having forward portions that project a second distance forwardly beyond the front end of the tractor chassis; and
the first distance being larger than the second distance.

2. The quad track vehicle of claim 1, wherein the left and right step arrangements include angled front fender portions that are generally parallel to the rear portions of the front left and right tracks, respectively, and wherein the left and right step arrangements include angled rear fender portions that are generally parallel to the front portions of the rear left and right tracks, respectively.

3. The quad track vehicle of claim 1, wherein rearmost portions of the rear left and right tracks define a first vertical reference plane, wherein frontmost portions of the rear left and right tracks define a second vertical reference plane, wherein rearmost portions of the front left and right tracks define a third vertical reference plane and wherein frontmost portions of the front left and right tracks define a fourth vertical reference plane.

4. The quad track vehicle of claim 3, wherein the seat is entirely between the first and second vertical reference planes.

5. The quad track vehicle of claim 3, wherein the second vertical reference plane passes through the footwell and intersects the steering wheel.

6. The quad track vehicle of claim 3, wherein bottommost steps of the left and right step arrangements are centered between the second and third vertical reference planes.

7. The quad track vehicle of claim 1, further comprising a trencher boom attached to the tractor chassis.

8. The quad track vehicle of claim 1, further comprising a vibratory plow attached to the tractor chassis.

9. The quad track vehicle of claim 1, further comprising a rock wheel attached to the tractor chassis.

10. The quad track vehicle of claim 1, further comprising a back-hoe attached to the tractor chassis.

11. A quad track vehicle comprising:
a non-articulated tractor chassis including a front end positioned opposite from a rear end and a left side positioned opposite from a right side;
a plurality of tracks on which the non-articulated tractor chassis is supported, each of the tracks defining a generally triangular shape, the plurality of tracks including a front left track positioned at the left side of the tractor chassis, a front right track positioned at the right side of the tractor chassis, a rear left track positioned at the left side of the non-articulated tractor chassis at a location rearward of the front left track and a rear right track positioned at the right side of the tractor chassis at a location rearward of the front right track;
a driver's seat supported on the non-articulated tractor chassis;
a steering wheel positioned in front of the driver seat;
a footwell positioned in front of the driver's seat at least partially beneath the steering wheel;
a step arrangement positioned at least partially between the front and rear left tracks or at least partially between the front and rear right tracks; and
a trenching implement attached to the non-articulated tractor chassis.

12. The quad track vehicle of claim 11, wherein the trenching implement includes a vibratory plow.
